(19) United States
(12) Patent Application Publication
(10) Pub. No.: US 2018/0128696 A1
(43) Pub. Date: May 10, 2018

(54) POT RUBBER BEARING, INTELLIGENT BEARING AND BEARING MONITORING SYSTEM

(71) Applicants: Shenzhen Municipal Design & Research Institute Co., Ltd., Shenzhen City (CN); Shenzhen Innova-Wise Engineering Technology Consulting Co., Ltd., Shenzhen City (CN)

(72) Inventors: Ruijuan Jiang, Shenzhen City (CN); Fang Yu, Shenzhen City (CN); Yiyan Chen, Shenzhen City (CN); Weiming Gai, Shenzhen City (CN); Jie Peng, Shenzhen City (CN); Jucan Dong, Shenzhen City (CN)

(73) Assignees: Shenzhen Municipal Design & Research Institute Co., Ltd., Shenzhen City (CN); Shenzhen Innova-Wise Engineering Technology Consulting Co., Ltd., Shenzhen City (CN)

(21) Appl. No.: 15/811,145

(22) Filed: Nov. 13, 2017

Related U.S. Application Data
(63) Continuation of application No. PCT/CN2016/097572, filed on Aug. 31, 2016.

(30) Foreign Application Priority Data
Jul. 18, 2016 (CN) 201610570209.0

(51) Int. Cl. G01L 1/22; F16C 33/20; E01D 19/04; G01L 1/20

(52) U.S. Cl. CPC G01L 1/2287; F16C 33/201; F16C 2233/00; G01L 1/205; E01D 19/047

(57) ABSTRACT

Disclosed are a pot rubber bearing, an intelligent bearing and a bearing monitoring system. The pot rubber bearing comprises a top bearing plate, a steel pot, a rubber plate and a base plate, wherein the base plate is stacked with the top bearing plate or the steel pot. A pressure sensing unit is arranged between the top bearing plate and the base plate or between the steel pot and the base plate. The intelligent bearing includes a data acquisition unit, a data output unit and the pot rubber bearing, the data acquisition unit transmits the bearing pressure measured by the pressure sensing unit to the data output unit. The bearing monitoring system includes a data acquisition unit, a data output unit, a monitoring center and the pot rubber bearing.

### CROSS-REFERENCE TO RELATED APPLICATIONS

This application is a Continuation application of International Application No. PCT/CN2016/097572, filed Aug. 31, 2016, which claims the benefit of priority of Chinese Application No. 201610570209.0, filed Jul. 18, 2016, the contents which are incorporated herein by reference in their entirety.

### FIELD OF THE INVENTION

The present disclosure relates to the technical field of bearings, in particular to a pot rubber bearing, an intelligent bearing and a bearing monitoring system.

### BACKGROUND OF THE INVENTION

Currently, pot rubber bearings are widely used in the field of bridges. They have been widely used in the actual bridge engineering in many countries around the world because of their remarkable isolation effects and the mature technology. In a bridge structure, the stability and reliability of the bearing which serves as a main force transfer component directly affects the safety performance of the entire bridge. Bearing failure will lead to the overall collapse of the entire bridge, resulting in immeasurable serious consequences, and therefore the long-term safety of the bearing is particularly important. For the pot rubber bearing, the failure of friction pairs and the fatigue and corrosion of metal components over time are all related to the overall safety of the bridge. From the long-term health situation of the bridge, it is particularly important to monitor the health status of the bearing.

In the prior art, the monitoring of the force condition for the isolation bearing mainly relies on a pressure sensing unit, and data information obtained after the sensing unit measures the pressure needs to be exported by a lead wire. Thus, there is a need to make micro-holes on the bearing to lead out the lead wire, thus causing the overall mechanical properties of the bearing to be affected. As the bridge bearing needs to bear a huge load, even tiny pores will cause huge safety risks. In addition, the replacement of the sensor unit is also a problem faced by the current bearing technology. Since the sensing unit is usually fixedly connected to the bearing body, if the sensor unit is to be replaced, the entire bearing needs to be replaced as well, leading to a high cost and complicated operation.

### SUMMARY OF THE INVENTION

The technical problem to be solved by the present disclosure is to provide a pot rubber bearing which is capable of monitoring the force condition of the bearing in real time, has no influence on mechanical properties of the bearing and facilitates replacement of the pressure sensing unit.

The further technical problem to be solved by the present disclosure is to provide an intelligent bearing and a bearing monitoring system which can monitor and reflect the health status of the bearing in real time.

The technical solution that the present disclosure adopts to solve the above technical problems is as follows: the present disclosure provides a pot rubber bearing, comprising a top bearing plate, a steel pot and a rubber plate arranged between the top bearing plate and the steel pot. The pot rubber bearing further comprises a base plate stacked with the top bearing plate or the steel pot, wherein a pressure sensing unit is arranged between the top bearing plate and the base plate or between the steel pot and the base plate.

As a further improvement of the above technical solution, the pressure sensing unit is a nano rubber sensor.

As a further improvement of the above technical solution, a stainless steel plate, an intermediate steel plate and a PTFE plate embedded in the intermediate steel plate are arranged between the top bearing plate and the rubber plate.

As a further improvement of the above technical solution, an array of nano rubber sensors are arranged between the top bearing plate and the base plate, or between the steel pot and the base plate.

As a further improvement of the above technical solution, the nano rubber sensor comprises at least two fabric layers, wherein nano-conductive rubber is filled between adjacent fabric layers, and the nano-conductive rubber is a rubber substrate into which carbon nanotubes are doped.

As a further improvement of the above technical solution, a limit unit is arranged on a lateral side of the base plate which is subjected to a lateral force.

As a further improvement of the above technical solution, the limit unit is a strip-shaped steel bar or limit block, and is fixedly connected to the top bearing plate or the steel pot by bolts and abuts against the side edge of the base plate.

The present disclosure provides an intelligent bearing, comprising a data acquisition unit, a data output unit, and the pot rubber bearing as described above, wherein the data acquisition unit transmits bearing pressure data measured by the pressure sensing unit to the data output unit.

The present disclosure further provides a bearing monitoring system, comprising a data acquisition unit, a data output unit, a monitoring center and the pot rubber bearing as described above. The data acquisition unit transmits bearing pressure data measured by the pressure sensing unit to the data output unit, and the data output unit transmits the pressure data to the monitoring center.

As a further improvement of the above technical solution, the monitoring center comprises a data receiving unit, a server, a monitoring unit, an analysis unit, and a human-computer interaction unit. The data receiving unit transmits the pressure data from the data output unit to the server, the monitoring unit, the analysis unit and the human-computer interaction unit.

The present disclosure has the beneficial effects that:

1. The pressure sensing unit is arranged between the top bearing plate and the base plate, or between the steel pot and the base plate, and is therefore easy to replace, and a real-time monitoring of the force state for the bearing can be realized.

2. The lead wire of the pressure sensing unit is led out from between the top bearing plate and the base plate, or from between the steel pot and the base plate, thus there is no need to make micro-holes for the lead wire on the bearing, ensuring that the mechanical properties of the bearing are not affected.

3. The bearing monitoring system of the present disclosure can instantaneously transmit the pressure data measured by the pressure sensing unit to the monitoring center which then monitors and analyzes the pressure data so as to monitor and reflect the health status of the bearing in real time.

### BRIEF DESCRIPTION OF THE DRAWINGS

FIGS. 1A-1B are cross-sectional views of an overall structure of a pot rubber bearing according to the first embodiment of the present disclosure, wherein FIG. 1A shows one sensor, and FIG. 1B shows a plurality of sensors;

FIG. 2 is a cross-sectional view of the overall structure of the pot rubber bearing according to the second embodiment of the present disclosure;

FIG. 3 is a cross-sectional view of the overall structure of the pot rubber bearing according to the third embodiment of the present disclosure;

FIG. 4 is a cross-sectional view of the overall structure of the pot rubber bearing according to the fourth embodiment of the present disclosure;

FIG. 5 is a schematic view of an overall structure of a nano rubber sensor of the pot rubber bearing of the present application; and

FIG. 6 is a schematic view showing the connection of modules of a bearing monitoring system of the present disclosure.

### DETAILED DESCRIPTION OF THE PRESENT INVENTION

In order that the objects, features and effects of the present disclosure may be fully understood, a full and clear description of concepts, specific structures and technical effects produced of the present disclosure will be made below in connection with embodiments and accompanying drawings. Obviously, the embodiments described are merely a part, but not all embodiments of the present disclosure. Based on the embodiments of the present disclosure, other embodiments obtained by those skilled in the art without inventive effort should all belong to the protection scope of the present disclosure. In addition, all the coupling/connecting relationships mentioned herein do not merely refer to direct connection or coupling of members, but rather a better coupling structures formed by adding or subtracting coupling accessories according to specific implementation. Technical features of the present disclosure may be combined as long as they are not mutually contradictory.

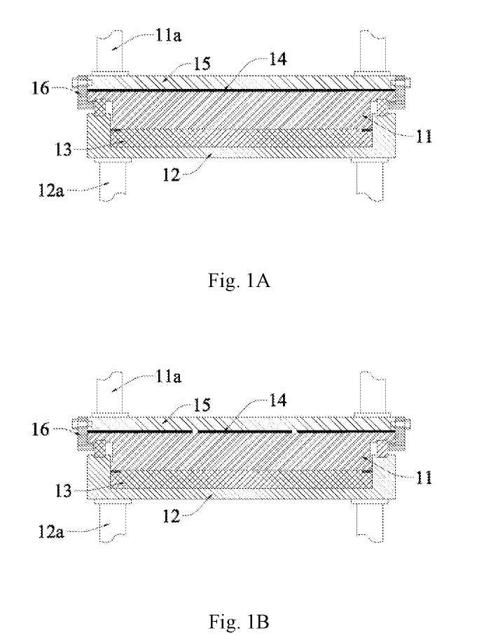

FIG. 1A shows a specific structure of a pot rubber bearing according to the first embodiment of the present disclosure. As shown in FIG. 1A, the pot rubber bearing of the present disclosure comprises a top bearing plate 11, a steel pot 12, a rubber plate 13, a nano rubber sensor 14, a base plate 15 and a limit unit 16.

The rubber plate 13 is arrange within the steel pot 12 and has a thickness smaller than the height of a side edge of the steel pot 12. A lower end of the top bearing plate 11 is arranged within the steel pot 12 and abuts tightly against the rubber plate 13. The nano rubber sensor 14 and the base plate 15 are arranged on the upper surface of the top bearing plate 11. The limit unit 16 is fixedly connected with the top bearing plate 11 by bolts and abuts against the side edge of the base plate 15.

The pot rubber bearing adopts the nano rubber sensor 14 to detect the force condition of the bearing in real time, and then obtains a vertical pressure variation value of the bearing. As the nano rubber sensor 14 is thin in thickness and simple in structure, it does not affect various mechanical properties of the bearing. As the rubber has good fatigue resistance and high temperature resistance, the nano rubber sensor 14 has a high durability and a number of alternating stress cycles greater than 50 million.

In preferred embodiments of the present disclosure, the nano rubber sensor 14 is used as a pressure measuring unit. Of course, other pressure sensors can also be used, such as but not limited to, a strain gauge pressure sensor, a ceramic pressure sensor, a diffused silicon pressure sensor, a piezoelectric pressure sensor, etc.

In this preferred embodiment, the base plate 15 and the nano rubber sensor 14 are arranged above the top bearing plate 11. The limit unit 16 is arranged on a lateral side of the base plate 15 which is subjected to a lateral force, so as to ensure the stability of the base plate 15 under the effect of the lateral force.

The limit unit 16, which is preferably a strip-shaped steel bar shown in FIG. 1A, is fixedly connected to the top bearing plate 11 by bolts and abuts against the lateral side of base plate 15. Of course, the shape, the fixed position and fixed manner of the limit unit 16 are not limited to the above-described embodiments, as long as the limiting function is achieved. The limit unit 16 and the top bearing plate 11 are connected by bolts to facilitate the replacement of the nano rubber sensor 14. In case of replacement, the limit unit 16 is taken off first, and then the base plate 15 together with the construction thereabove is jacked using a jacking device, thus the nano rubber sensor 14 can be replaced.

In order to accurately measure the force condition of the entire bearing and ensure the availability of monitoring under a partial loading situation at the same time, preferably, an array of the nano rubber sensors 14 is arranged between the top bearing plate 11 and the base plate 15, as shown in FIG. 1B. High-temperature-resistance shielding lead wires 17 connecting two electrodes of the nano rubber sensor 14 are led out from a gap between the base plate 15 and the top bearing plate 11, thus there is no need to make micro-holes for the lead wires on the bearing, effectively ensuring the mechanical properties of the bearing.

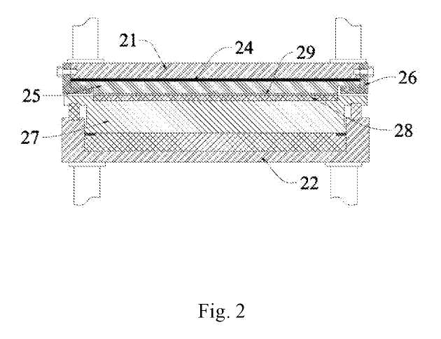

FIG. 2 shows a specific structure of the pot rubber bearing according to a second embodiment of the present disclosure. As shown in FIG. 2, the pot rubber bearing of the present disclosure comprises a top bearing plate 21, a steel pot 22, a rubber plate 23, a nano rubber sensor 24, a base plate 25, a limit unit 26, an intermediate steel plate 27, a PTFE plate 28 and a stainless steel plate 29.

Both the nano rubber sensor 24 and the base plate 25 are arranged below the top bearing plate 21, and the PTFE plate 28 is embedded into the intermediate steel plate 27. A friction pair is formed between the stainless steel plate 29 and the PTFE plate 28 below the base plate 25, and the relative friction coefficient between the stainless steel plate 29 and the PTFE plate 28 is small, so that a small horizontal displacement may occur therebetween to release the temperature loading of the bearing. The limit unit 26 is fixedly connected with the top bearing plate 21 by bolts and abuts against the lateral side of the base plate 25.

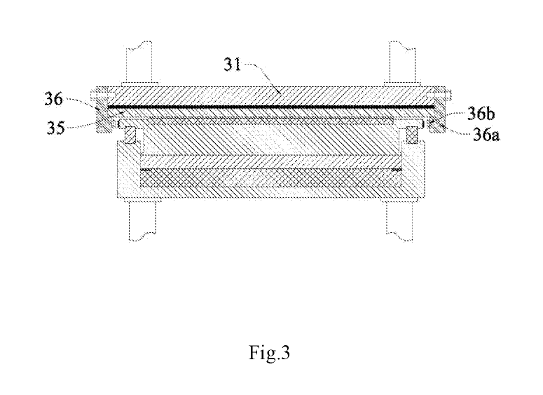

FIG. 3 shows a specific structure of the pot rubber bearing according to a third embodiment of the present disclosure. The difference between this embodiment and the second embodiment lies in that not only the base plate 35 is limited by the limit unit 36, but also an extension end 36a of the limit unit 36 provides some cushioning and limiting effect to the intermediate steel plate 27 arranged therebelow. In particular, the extension end 36a of the limit unit 36 sets a range of relative sliding for the top bearing plate 31 and the intermediate steel plate 27, that is, defining the range of relative sliding for the top bearing plate 31 and the steel pot 32. The extension end 36a is provided with a high-damping rubber strip 36b which can provide a good cushioning and damping effect.

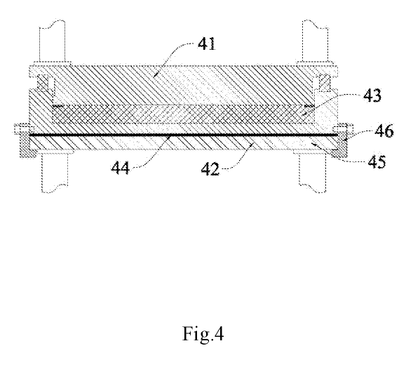

FIG. 4 shows a specific structure of the pot rubber bearing according to a fourth embodiment of the present disclosure. As shown in FIG. 4, the pot rubber bearing of the present disclosure comprises a top bearing plate 41, a steel pot 42, a rubber plate 43, a nano rubber sensor 44, a base plate 45 and a limit unit 46. The difference between this embodiment and the first embodiment lies in that the nano rubber sensor 44 and the base plate 45 are arranged below the steel pot 42.

In this embodiment, upon replacing the nano rubber sensor 44, the limit unit 46 is taken off first, and then the top bearing plate 41, the construction above the top bearing plate 41, the rubber plate 43 and the steel pot 42 are simultaneously jacked up to allow replacement of the nano rubber sensor 24. Since the top bearing plate 41 and the rubber plate 43, and the rubber plate 43 and the steel pot 42 are in non-fixed connection, in order to facilitate the overall jacking of the components above, preferably a locking mechanism can be used to lock the above components together as one piece during jacking.

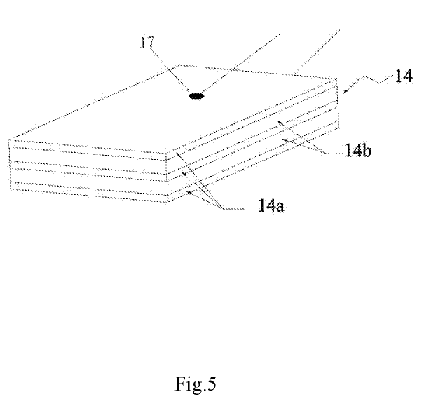

FIG. 5 shows a schematic view of the overall structure of the nano rubber sensor 14 of the pot rubber bearing of the present disclosure.

The operating principle of the nano rubber sensor is as follows: the nano rubber sensor is deformed under the action of an external load, so that distances between conductive particles in the conductive rubber are changed, and thus a conductive network formed by the conductive particles is changed, represented by changes in the resistivity and resistance of the conductive rubber, which consequently causes changes in the measurement of electrical signals. Then, according to the piezoresistive characteristics of the conductive rubber, the force condition of a pressure bearing surface can be derived.

Preferably, the nano rubber sensor 14 is of a multilayer structure, wherein as skeleton layers, a plurality of high strength fabric layers 14a are distributed at intervals from top to bottom, and nano-conductive rubber 14b of a certain thickness is filled between the fabric layers 14a. The fabric layers 14a are dense in texture, and have a certain thickness, elasticity and strength, satisfying the requirement of elastic deformation under a high pressure without being damaged. Preferably, the fabric layers 14a are made of elastic fibers such as medium or high class spandex, high-elastic nylon, etc. At the same time, there are gaps in the texture formed by the vertical and horizontal fibers of the fabric layers 14a, which ensure that a nano-conductive rubber solution covered on the fabric layers 14a can infiltrate into the gaps during preparation, thereby enhancing the integrity of the structure. The rubber substrate material of the nano-conductive rubber 14a is polydimethylsiloxane rubber (PDMS) consisting of basic constituents and a curing agent in a mixing ratio of 10:1, the conductive fillers are carbon nanotubes, preferably multi-walled carbon nanotubes (MWCNT). The mass percentage of the multi-walled carbon nanotubes is between 8% and 9%.

The high strength fabric layers 14a are added to the nano rubber sensor 14 as a stiff skeleton, which significantly improves the strength and toughness of the nano rubber sensor 14 under a high pressure of 0 to 50 MPa, avoiding tearing and ensuring the stability and repeatability of such sensing unit under high pressure.

The preparation of nano rubber sensor is carried out mainly by solution blending and molding. The specific preparation method comprises the following steps:

S1, ingredient mixing: weighing the basic constituents of polydimethylsiloxane rubber (PDMS), the curing agent and carbon nanotubes in accordance with a mass ratio, pouring the mixture into a mixer, and grinding and mixing the same mechanically at room temperature to ensure that the carbon nanotubes are uniformly distributed in the rubber substrate to make the nano-conductive rubber solution.

S2, synthesis: preparing a plurality of high-strength fabrics of the same size, laying a fabric layer on a bottom plate of a mold, uniformly coating the nano-conductive rubber solution prepared in S1 onto the fabric at a certain thickness, and then laying another fabric layer on the same, wherein depending on the thickness required for a nano-conductive rubber sensing element, the process of coating the nano-conductive rubber solution and additionally laying the fabric layer can be repeated.

S3, curing: placing a top plate of the mold on the uppermost fabric layer of the uncured nano rubber sensor; through the connection between the upper top plate and the lower bottom plate of the mold, applying a certain pressure to the nano-conductive rubber material to ensure uniformity and compactness of the thickness thereof; and placing the mold in a container at 60° C., vacuuming the container and leaving it for at least 300 min.

After the nano rubber sensor is cured, the cured sheet type nano rubber sensor can be cut into desired sizes and shapes by machining tools according to design requirements of the sensor. After connecting electrodes and an insulating protective layer, a sheet-type flexible nano-conductive rubber pressure sensor having a large measuring range is fabricated.

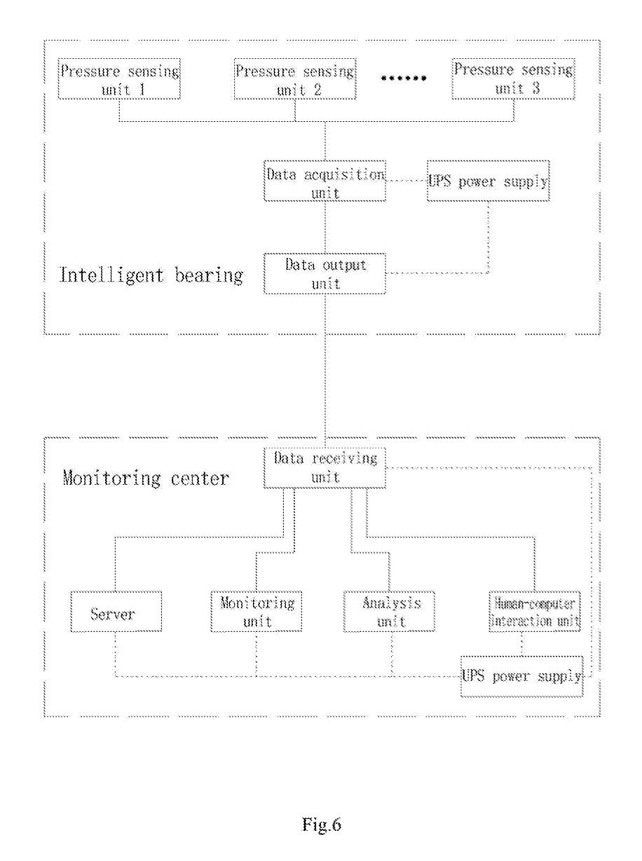

FIG. 6 is a schematic view showing the connection of modules of a bearing monitoring system of the present disclosure. The bearing monitoring system of the present disclosure includes an intelligent bearing and a monitoring center.

The intelligent bearing comprises the pot rubber bearing as described above, a data acquisition unit, a data output unit, and a UPS power supply. The data acquisition unit acquires pressure data of each of the nano rubber sensors in the pot rubber bearing. The data output unit is preferably an optical wireless switch, which transmits the pressure data to the monitoring center. The UPS provides uninterrupted power to every electricity-consuming module in the intelligent bearing.

The monitoring center comprises a data receiving unit, a server, a monitoring unit, an analysis unit, a human-computer interaction unit and a UPS power supply. The data receiving unit is also preferably an optical wireless switch, which is used to receive the pressure data transmitted by the data output unit. The data receiving unit transmits the received data to the server, the monitoring unit, the analysis unit and the human-computer interaction unit, the server manages and controls the data, the monitoring unit performs instant monitoring on the data, and the analysis unit evaluates and analyzes the data. The UPS power supply provides uninterrupted power to every electricity-consuming module in the monitoring center.

Through the acquisition, transmission, monitoring and analysis performed on the monitoring data of the bearing, the bearing monitoring system can instantly understand and judge the health status of the bearing to ensure the safe use of the bearing.

Preferred embodiments of the present disclosure have been described above, but the present disclosure is not limited thereto. Numerous variations, substitutions and equivalents may be made by those skilled in the art without departing from the spirit of the disclosure and should all fall within the scope defined by the claims of the present application.

1. A pot rubber bearing, comprising
a top bearing plate,
a steel pot and a rubber plate arranged between the top bearing plate and the steel pot,
a base plate stacked with the top bearing plate or the steel pot, and
at least one pressure sensing unit arranged between the top bearing plate and the base plate, or between the steel pot and the base plate.

2. The pot rubber bearing according to claim 1, wherein the pressure sensing unit is a nano rubber sensor.

3. The pot rubber bearing according to claim 2, wherein a stainless steel plate, an intermediate steel plate and a PTFE plate embedded in the intermediate steel plate are further arranged between the top bearing plate and the rubber plate.

4. The pot rubber bearing according to claim 2, wherein an array of the nano rubber sensors is arranged between the top bearing plate and the base plate, or between the steel pot and the base plate.

5. The pot rubber bearing according to claim 2, wherein the nano rubber sensor comprises at least two fabric layers, wherein nano-conductive rubber is filled between adjacent fabric layers, and the nano-conductive rubber is a rubber substrate into which carbon nanotubes are doped.

6. The pot rubber bearing according to claim 1, wherein a limit unit is arranged on a lateral side of the base plate which is subjected to a lateral force.

7. The pot rubber bearing according to claim 6, wherein the limit unit is a strip-shaped steel bar or limit block, and is fixedly connected to the top bearing plate or the steel pot by bolts and abuts against the lateral side of the base plate.

8. An intelligent bearing, comprising:
a data acquisition unit,
a data output unit, and
the pot rubber bearing according to claim 1,
wherein the data acquisition unit transmits bearing pressure data measured by the pressure sensing unit to the data output unit.

9. A bearing monitoring system, comprising:
a data acquisition unit,
a data output unit,
a monitoring center, and
the pot rubber bearing according to claim 1,
wherein the data acquisition unit transmits the bearing pressure data measured by the pressure sensing unit to the data output unit, and the data output unit transmits the pressure data to the monitoring center.

10. The bearing monitoring system according to claim 9, wherein the monitoring center includes:
a data receiving unit,
a server,
a monitoring unit,
an analysis unit, and
a human-computer interaction unit,
wherein the data receiving unit transmits the pressure data from the data output unit to the server, the monitoring unit, the analysis unit and the human-computer interaction unit.
